(19) United States
(12) Patent Application Publication
(10) Pub. No.: US 2003/0005627 A1
(43) Pub. Date: Jan. 9, 2003

(54) Musical floral wrap

(76) Inventor: Daniel Temkin, Orem, UT (US)

Correspondence Address: TRASK BRITT, P.O. BOX 2550, SALT LAKE CITY, UT, 84110, US

(21) Appl. No.: 09/901,948

(22) Filed: Jul. 9, 2001

(51) Int. Cl. A01G 9/02

(52) U.S. Cl. 47/72

(57) ABSTRACT

The present invention relates to a floral wrap and a sound circuit. More specifically, the invention encompasses a sound circuit, which is attached to a floral or plant sleeve.

### TECHNICAL FIELD

The invention relates to floral and plant wraps.

### BACKGROUND

A floral wrap or sleeve is generally designed to hold flowers in a preselected orientation. Floral wrapping is generally prepared with wrapping paper, which may either be wrapped around a bouquet of flowers or flower pot, or formed as a tapered sleeve to hold a bouquet of flowers.

On many occasions, such as birthdays, holidays, and the like, it is desirable to do more for a person than merely sending the person a bouquet of flowers. Previous attempts to “spruce up” the standard floral wrap include using colored paper, designs on the sheets of paper and different types of paper. While these ideas may provide additional enjoyment upon viewing the flowers, there is still a desire to improve upon the standard bouquet or pot of flowers.

Thus what is needed in the art is new way to enhance a floral or plant sleeve that provides extra enjoyment to the recipient of such an item.

### SUMMARY OF THE INVENTION

The present invention discloses a floral wrap that includes a wrapping element suitable for wrapping a floral arrangement, and a sound producing device that is physically associated with the wrapping element. Similarly, the sound producing device may also be physically associated with a sleeve for a flower pot.

BRIEF DESCRIPTION OF THE DRAWINGS

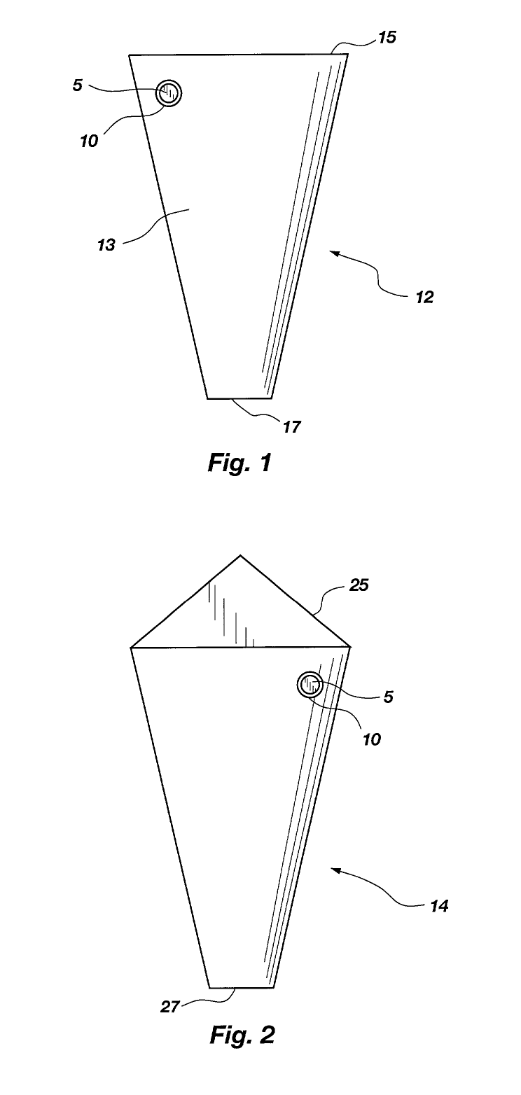

FIG. 1 is a side view of a floral sleeve of the invention having a sound producing device.

FIG. 2 is a side view of a second embodiment of a floral sleeve having a sound producing device.

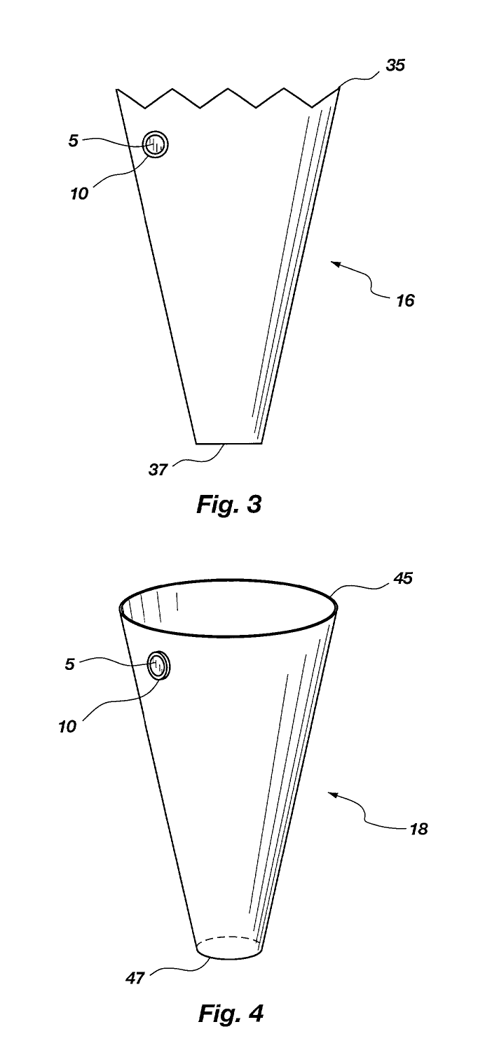

FIG. 3 is a side view of a third embodiment of a floral sleeve having a sound producing device.

FIG. 4 is a perspective view of a fourth embodiment of a floral sleeve having a sound producing device.

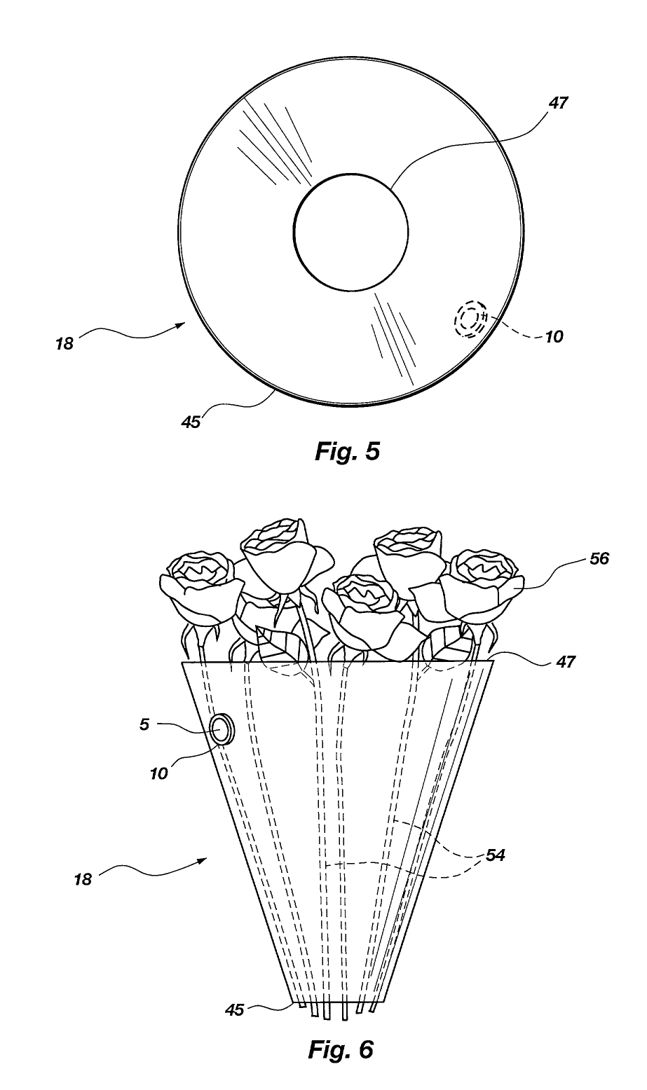

FIG. 5 is a top view of the floral sleeve shown in FIG. 4.

FIG. 6 is a side view of a floral sleeve including a sound producing device and flowers.

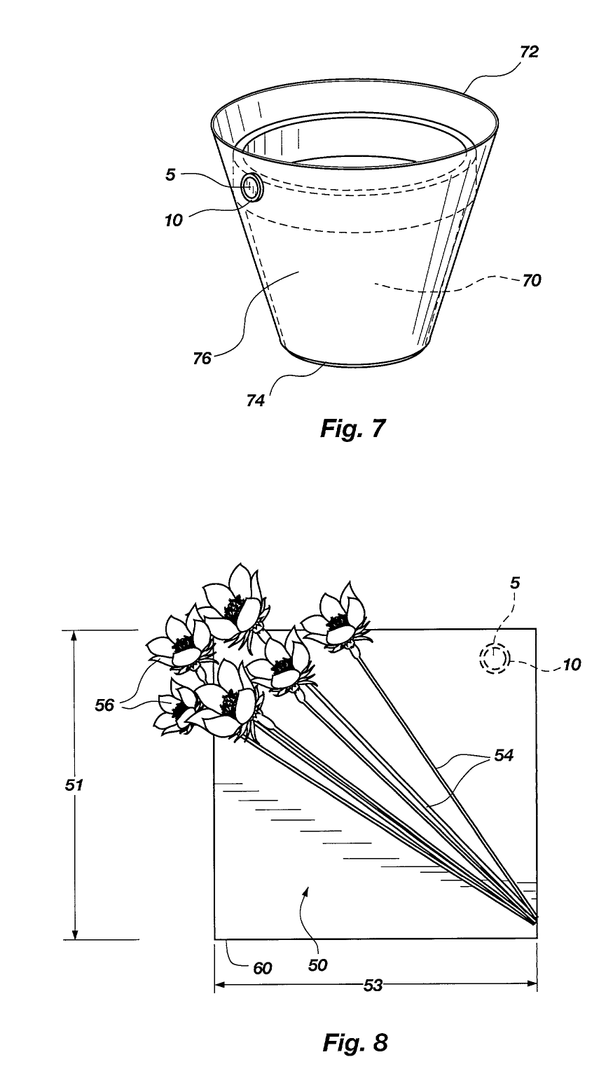

FIG. 7 is a perspective view of a pot cover enwrapped by a plant sleeve containing a sound producing device.

FIG. 8 is a plan view of another embodiment of the floral wrap of the invention.

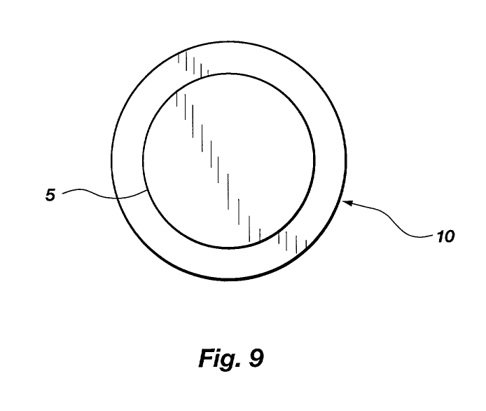

FIG. 9 is a plan view of the sound producing device.

### DETAILED DESCRIPTION OF THE EMBODIMENTS

The present invention discloses a floral wrap which includes a wrapping element having a sound producing device associated therewith. As shown in FIG. 1, a floral wrap, designated generally by the reference numeral 12 includes a wrapping element which is constructed in accordance with the present invention. The term “floral wrap” may include, but is not limited to floral wraps, plant sleeves, floral sleeves or other types of wrapping elements used to hold a floral bunch. The wrapping element includes at least one sheet of material 13. The sheet of material 13 has an upper edge 15, a lower edge 17, and an outer periphery (which is not illustrated). The sheet of material 13 can be configured to retain a floral arrangement. As used herein, the term “floral arrangement” may include, but is not limited to, cut fresh flowers, artificial flowers, other fresh and/or artificial plants or other floral materials such as a flower pot, and may also include other secondary plants and/or ornamentation or artificial or natural materials or combinations thereof which contribute to the aesthetics of the overall floral arrangement.

In the embodiment of FIG. 1, the sheet of material 13 is configured into a conical shape. It is flared at the upper edge 15 and tapered at the bottom edge 17. It should be appreciated, however, that numerous shapes and sizes of sheet 13 or sleeves may be used to wrap a floral arrangement, as long as it is sufficiently sized and shaped to wrap about and encompass the floral arrangement. For example, as seen in FIGS. 2-4 and 8 sheets 13 configured in shapes such as, round, rectangular, oval, asymmetrical or the like may be used in the invention. Additionally, it will be appreciated that the sheet of material 13 shown in all embodiments herein is initially substantially planar in configuration.

The sheet of material 13 may be constructed of a single sheet of material or a plurality of sheets. The sheet 13 may be manufactured by adhering a first edge and a second edge of the sheet to one another to form a cone-like structure. Any thickness of the sheet of material 13 may be utilized in accordance with the present invention, provided that the sheet of material 13 may be wrapped about at least a portion of a floral arrangement. A preferred thickness of the sheet of material 13 is between approximately 20 microns to 75 microns. In a more preferred embodiment, the sheet of material 13 is constructed from one sheet of polymer film having a thickness in a range of from about 30 microns to 50 microns.

The sheet of material 13 is constructed from any suitable wrapping material that is capable of being wrapped about a flower pot or floral arrangement. Preferably, the wrapping element is constituted from paper (untreated or treated in any manner), cellophane, foil, polymer film, fabric (woven or nonwoven or synthetic or natural), burlap, mylar or combinations thereof. The term “polymer film” may include any man-made polymer, such as a polypropylene, or any naturally occurring polymer, such as cellophane. A polymer film is relatively strong and not as subject to tearing (substantially non-tearable) as might be the case with paper or foil. Types of paper and/or film that can be used in floral wrap constructions include clear, metallic, pearl, illusion paper, a waterproof material with the look and feel of paper, and synthetic paper, which a white waterproof paper-like material suitable for floral wraps.

Additionally, the sheet of material 12 may vary in color. Examples of such colors include blue, purple, green, yellow, red, orange, pink, colorless, white, black, gray, brown, or any combination thereof. The colors may be utilized alone, or in any combination. Further, the sheet of material 12 may have any type of design on its cover, backside, edges and sides, such as balloons, the wording “Happy Birthday” or “Happy Valentines”, musical notes, etc., which are printed, etched, and/or embossed thereon. Moreover, the sheet of material 13 may have various colorings, coatings, and/or metallic finishes, applied separately or simultaneously or may be characterized totally or partially by pearlescent, translucent, transparent, iridescent, or the like, qualities. Each of the above-named characteristics may occur alone or in combination. Moreover, the border regions of the sheet of material 13 may vary in the combination of such characteristics.

FIG. 1 also illustrates a sound producing assembly which may include a sound circuit 10, a power source and a switch 5 cooperating to provide audible sound when the switch is actuated. The sound producing assembly may be mechanically associated with the sheet of material 13 in a non-obtrusive manner via tape, glue or other attachment means known in the art. The sound producing assembly is mechanically associated with the wrap so as to be physically accessible to the user once the wrap is positioned around a floral arrangement. The sound circuit 10 includes a printed circuit board (not shown) supported within an interior cavity by conventional support means (not shown). The sound circuit 10 is fabricated entirely in accordance with conventional fabrication techniques. The sound circuit 10 includes an integrated sound circuit having a plurality of additional components, such as components supported upon printed circuit board, which includes conventional conductive coupling pads therebetween (not shown). The printed circuit board further supports a switch 5 and at least one battery, operatively coupled to the remainder of sound circuit 10 in accordance with conventional fabrication means. Any readily commercially available sound circuit and/or music module may be used with the floral wrap or pot cover.

The sound circuit 10 may be fabricated entirely in accordance with conventional fabrication techniques with the essential function of sound circuit 10 being the provision of appropriate signals to an integrated speaker each time the switch 5 is pressed. For example, a combination of a microprocessor, read only memory, speech synthesizer, and audio output amplifier suitable for the function of a sound circuit 10 may be formed as a single integrated circuit chip device. However, it will be understood by those skilled in the art that a variety of standard integrated sound circuit devices may be utilized for sound circuit 10.

Various types of sound may be produced by the sound circuit 10. Examples include various musical greetings, such as the “Birthday Song”, or “Don't Worry, Be Happy”, or may include just simple phrases, such as “I Love You” or “Happy Birthday”. Additionally, the floral wrap or the sound circuit 10 may include the words “Press button for sound” or “Press Here” printed on the wrap near the sound circuit 10 or on the sound circuit or switch 5. Additionally, the sound circuit 10 may be actuated by sound, light or temperature besides touch.

FIGS. 2-4 illustrate additional embodiments of the present invention. FIG. 2 depicts a floral wrap designated generally by the reference numeral 14 shows a top edge 25 that may be folded over a floral arrangement, along with a tapered bottom edge 27. FIG. 3 includes a floral wrap designated generally by the reference numeral 16 illustrates another possible embodiment of the invention. The top edge 35 is designed in a diamond pattern while the bottom edge 37 is tapered as compared to the top edge. FIG. 4 is a perspective view which discloses a floral wrap designated generally by the reference numeral 18 illustrates an additional embodiment of the present invention. The wrap 18 includes a top edge 45 that gradually tapers to a bottom edge 47. Additionally, all of the aforementioned plant wraps contain the sound circuit 10 as previously disclosed.

FIG. 5 illustrates a perspective view from the top of the floral wrap illustrated in FIG. 4. The wrap 18 is positioned to illustrate that the top edge 45 is configured in a circular fashion and tapers down into a smaller circular bottomed edge 47. Again the sound circuit 10 is illustrated as being attached to the wrap.

FIG. 6 illustrates a floral arrangement retained in the floral wrap 18 of FIG. 4. The floral arrangement illustrated comprises blooms 56 or a foliage portion and a stem portion 54 wherein the stems 54 extend beyond the bottom edge 45 of the wrap 18. However, it is appreciated that the floral arrangement may consist of only a single bloom or only foliage (not shown). Again, the sound circuit 10 may be placed anywhere on the wrap 18 so as to be physically accessible to the user once the wrap is positioned around a floral arrangement.

FIG. 7 illustrates another embodiment of the present invention. As shown, a flower pot 70 is illustrated. The term “flower pot” refers to any type of container used for holding a floral arrangement or a potted plant that is retained with a plant sleeve 76. The sleeve 76 that covers the flower pot includes a base 74 and a top edge 72 that encircles the pot. The sleeve also includes a sound circuit 10.

In the embodiment of FIG. 8, the sheet of material 50 is square and is designed to wrap the flowers rather than hold the flowers as illustrated in the embodiments of FIGS. 1-4. The term “wrap” used in this context means a method used to wrap at least one sheet of material about a floral arrangement. It will be appreciated, however, that any shape or size of sheet 50 may be used to wrap a flower pot or a floral arrangement, so as long as it is sufficiently sized and shaped to wrap and encompass a flower pot or floral arrangement. For example, the sheet 50 may also include other shapes, i.e., rectangular, round, oval, octagonal, asymmetrical, or the like. Additionally, multiple sheets of material 50 may be used. Moreover, when multiple sheets of material 50 are used in combination, the sheets of material 50 need not be uniform in size or shape. Finally, it will be appreciated that the sheet of material 50 shown in all embodiments herein is substantially flat.

The sheet of material 50 has a width 51 which is sufficiently sized whereby the sheet of material 50 can be wrapped about and encompass a floral arrangement or a flower pot. The sheet of material 50 has a length 53 which extends generally between a first side and a second side of the sheet of material 50. The sheet extends over a substantial portion of the floral arrangement when the sheet of material 50 has been wrapped about the floral arrangement in accordance with the present invention.

FIG. 8 also shows a floral arrangement having stems 54 and blooms 56 which are disposed on the outward facing surface of the sheet of material 50. The sheet of material illustrated in FIG. 8 is then wrapped around the floral arrangement and may be affixed by a tie, rubber band, adhesive tab or other enclosure means known in the art.

FIG. 9 depicts the sound producing assembly which may include a sound circuit 10, a power source and a switch 5 cooperating to provide audible sound when the switch is actuated.

Thus, the present invention provides a wide variety of standard and customized designer floral wraps and film that enhances the appearance of bouquets of flowers or plants. An assortment of sizes and styles, e.g., straight-edged, scallop-edged, or a hybrid may be chosen. Additionally, the floral wraps are developed to complement, not to compete, with the flowers.

While certain representative embodiments and details have been shown for purposes of illustrating the invention, it will be apparent to those skilled in the art that various changes in the invention as disclosed herein may be made without departing from the scope of the invention, which is defined in the appended claims.

What is claimed is:

1. A floral wrap comprising:
a sheet of material having an edge, said material being suitable for wrapping a floral arrangement; and
a sound producing device physically associated with said sheet of material.

2. The floral wrap of claim 1 wherein said sound producing device is configured to be operable upon a force-sensitive contact, sound-sensitive contact, light-sensitive contact or temperature sensitive contact.

3. The floral wrap of claim 1 wherein said sound producing device is a piezoelectric device.

4. The floral wrap of claim 1 wherein said sheet of material is constructed from a material selected from the group consisting of illusion paper, synthetic paper, tissue paper, rice paper, polymer film, polypropylene, cellophane, foil, polyurethane paper and the like.

5. A floral wrap comprising:
a conical shaped sleeve suitable for wrapping about floral arrangement; and
a sound producing device mechanically associated to said sleeve.

6. The floral wrap of claim 5 wherein said sound producing device is configured to be operable upon a force-sensitive contact, sound-sensitive contact, light-sensitive contact or temperature sensitive contact.

7. The floral wrap of claim 5 wherein said sound producing device is a piezoelectric device.

8. The floral wrap of claim 5 wherein a top edge of said conical shaped sleeve is shaped in a straight-edged or non-linear formation.

9. The floral wrap of claim 5 wherein said conical shaped sleeve is constructed from a material selected from a group consisting of illusion paper, synthetic paper, tissue paper, rice paper, polymer film, polypropylene, cellophane, foil, polyurethane paper and the like.

10. A method of wrapping a floral arrangement comprising:
providing a sheet of material having an edge wherein said sheet of material is mechanically associated with a sound producing device;
providing a floral arrangement;
wrapping said sheet of material about said floral arrangement.

11. The method according to claim 10 wherein said sound producing device is configured to be operable upon a force-sensitive contact, sound-sensitive contact, light-sensitive contact or temperature sensitive contact.

12. The method according to claim 10 wherein said sound producing device is a piezoelectric device.

13. The method according to claim 10 wherein said sheet of material is constructed from a material selected from the group consisting of illusion paper, synthetic paper, tissue paper, rice paper, polymer film, polypropylene, cellophane, foil, polyurethane paper and the like.

14. A preformed sleeve comprising:
a sheet of material having first and second sides;
a sound producing device mechanically associated to said sheet of material wherein said sound producing device is configured to be operable upon a force sensitive contact.

15. The preformed sleeve of claim 14 configured to wrap a floral arrangement.

16. The preformed sleeve of claim 14 configured to wrap around a flower pot.

17. The preformed sleeve of claim 14 wherein said sleeve is constructed from a material selected from the group consisting of illusion paper, synthetic paper, tissue paper, rice paper, polymer film, polypropylene, cellophane, foil, polyurethane paper and the like.

18. An improvement in wrapping paper of the type used to wrap a flower pot or other floral arrangement, the improvement comprising mechanically associating a sound producing device to said wrapping paper at a location which is physically accessible upon a placement of said wrapping paper about said floral arrangement.
